(19) United States
(12) Patent Application Publication
(10) Pub. No.: US 2017/0355939 A1
(43) Pub. Date: Dec. 14, 2017

(54) DEVICES AND METHODS FOR REMOVAL OF BIOGENIC AMINES FROM WINES AND OTHER LIQUIDS

(71) Applicant: Jay Yadav, Sandy Springs, GA (US)

(72) Inventor: Jay Yadav, Sandy Springs, GA (US)

(21) Appl. No.: 15/483,469

(22) Filed: Apr. 10, 2017

Related U.S. Application Data
(60) Provisional application No. 62/347,761, filed on Jun. 9, 2016.

(51) Int. Cl. C12H 1/04; B01D 15/36; C02F 1/42; C12H 1/07; C02F 101/38

(52) U.S. Cl. CPC C12H 1/0432; C02F 1/42; C12H 1/063; B01D 15/362; C02F 2001/425; C02F 2101/38

(57) ABSTRACT

Methods and devices for use in removing biogenic amines from wine or other liquids are described. The methods and devices use a cation exchange resin and/or molecularly imprinted medium selective for amines to remove the amines from the wine or other liquid at the point of use.

### CROSS REFERENCE TO RELATED APPLICATIONS

This application claims the benefit of priority to U.S. Provisional Application 62/347,761, filed Jun. 9, 2016, which is incorporated by reference herein in its entirety.

### BACKGROUND

Biogenic amines are a group of compounds produced by microorganisms during the wine manufacturing process, primarily through decarboxylation of amino acids. It has been shown that these amines can be a cause of headache for individuals who consume wine. See Smit et al., Biogenic Amines in Wine: Understanding the Headache, Afr. J. Enol. Vitic. 29(2):109-238 (2008). While there can be others, a list of eleven biogenic amines commonly found in wine is presented in Table 1.

TABLE 1
Biogenic amines found in wines

| Type | Common Name | Structure/Chemical Name |
|---|---|---|
| aliphatic amines | Putrescine | NH₂—(CH₂)₄—NH₂ |
| | Cadaverine | NH₂—(CH₂)₅—NH₂ |
| | Ethylamine | CH₃—CH₂—NH₂ |
| | Methylamine | CH₃—NH₂ |
| | Agmatine | NH₂—(CH₂)₄—N═C(NH₂)₂ |
| | Spermidine | NH₂—(CH₂)₄—NH—(CH₂)₃—NH₂ |
| | Spermine | NH₂—(CH₂)₃—NH—(CH₂)₄—NH—(CH₂)₃—NH₂ |
| aromatic amines | Tyramine | HO—C₆H₅—CH₂—CH₂—NH₂ |
| | β-phenylethylamine | C₆H₅—CH₂—CH₂—NH₂ |
| heterocyclic amines | Histamine | 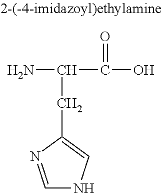 [SMILES: NC(Cc1c[nH]cn1)C(=O)O] |
| | Tryptamine | 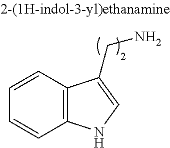 |

### SUMMARY

In accordance with the purposes of the disclosed materials, compositions, devices, and methods, as embodied and broadly described herein, the disclosed subject matter, in one aspect, relates to methods for removing one or more amines from wine or other liquid samples at the point of use. The disclosed methods also relate to devices for use in removing amines from wine or other liquids. The disclosed devices comprise a cation exchange resin and/or molecularly imprinted medium selective for amines.

Additional advantages of the disclosed subject matter will be set forth in part in the description that follows, and in part will be obvious from the description, or can be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying figures, which are incorporated in and constitute a part of this specification, illustrate several aspects described below.

FIG. 1 is a first perspective view of a device according to one implementation.

FIG. 2 is a second perspective view of the device shown in FIG. 1.

FIG. 3 is a longitudinal cut-a-way view of the device shown in FIG. 1, showing an internal cavity of the device.

FIG. 4 is a cross-sectional view of a device located inside the neck of a bottle according to another implementation.

FIG. 5 is a cross-sectional side view of the device shown in FIG. 4.

FIG. 6 is a side view of the device shown in FIG. 4.

FIG. 7 is a side view of a device according to one implementation, showing slits defined in a lower portion of the body.

FIG. 8 is a cross-sectional view of a device according to one implementation in which the lower portion is disposed outside the neck of a bottle.

FIG. 9 is a graph of pH over time for various aqueous phases contacted with Amberlyst 15 ion exchange resin.

FIG. 10 is a graph of pH over time for various aqueous phases spiked with biogenic amines and contacted with Amberlyst 15 resin.

FIG. 11 is a graph of pH over time for various aqueous phases spiked with 10% ethanol and biogenic amines and contacted with Amberlyst 15 resin.

FIG. 12 is a decanter comprising a cartridge filled with cation exchange resin and/or molecularly imprinted medium.

### DETAILED DESCRIPTION

The materials, compositions, devices, and methods described herein may be understood more readily by reference to the following detailed description of specific aspects of the disclosed subject matter and the Examples and Figures included therein.

Before the present materials, compositions, devices, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### Devices

Disclosed herein is a device and a method for removing or reducing biogenic amines from wine or other liquids at the point of use. In various embodiments, the device has a generally elongated body having a lower portion and an upper portion. At least a portion of the lower portion is configured to engage the neck of a bottle and defines one or more openings configured for receiving liquid from the bottle. An internal cavity is defined between the upper and lower portions. Liquid entering the one or more openings of the lower portion flows into the internal cavity of the body. A cation exchange resin or molecularly imprinted medium, or a cartridge containing a cation exchange resin or molecularly imprint medium, is disposed within the internal cavity. After liquid flows through the internal cavity and past the resin, medium, or cartridge, the liquid flows through one or more openings defined in the upper portion to exit the internal cavity. It is to be understood that there are many different bottle shapes currently in use for wine and other liquids, and the disclosed devices are intended to be adaptable and usable in most if not all such bottle designs.

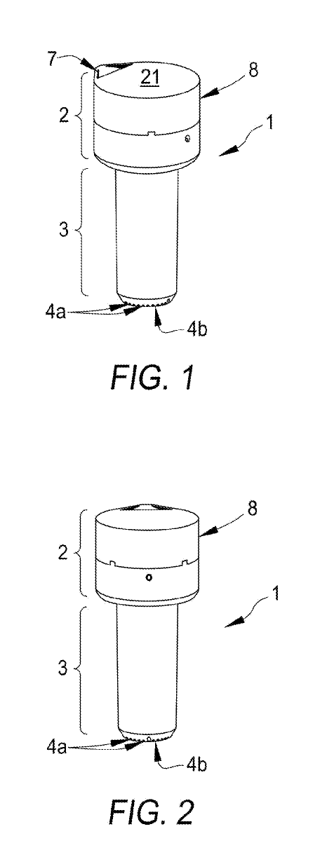

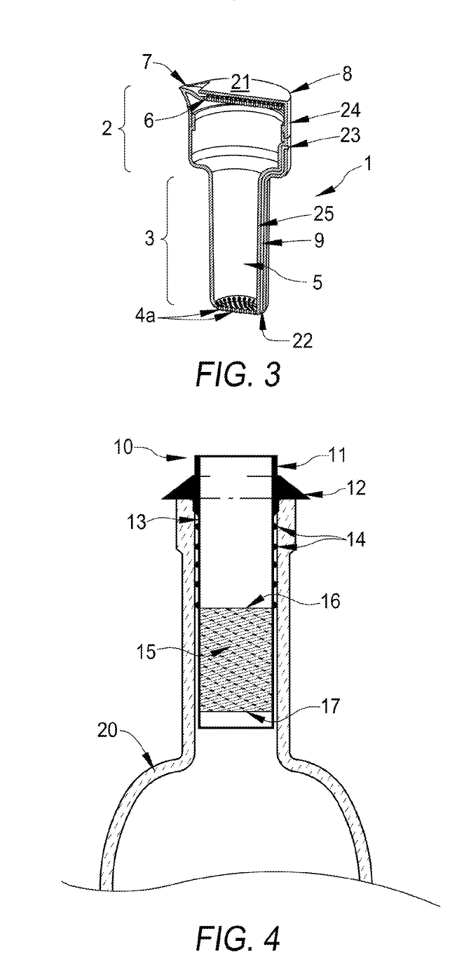

FIGS. 1-3 show one exemplary embodiment of a device 1. The device 1 has a generally elongated body, with an upper portion 2 and a lower portion 3. An internal cavity 5 is defined between the upper 2 and lower portions 3. A bottom surface 4b of the lower portion 3 defines one or more openings 4a configured for allowing liquid to enter the internal cavity 5 through the openings 4a. A cation exchange resin and/or molecularly imprinted medium, or cartridge containing these materials, (not shown) is disposed within the internal cavity 5.

An outer diameter of the lower portion 3 has a diameter that is slightly smaller than an internal diameter of most commercially available bottles such that at least a portion of the lower portion 3 fits within the neck of the bottle and prevents liquid from exiting the bottle except through the device 1. Most bottles in commercial use for products such as wine have an internal diameter of about 16.36 mm to about 19.81 mm. Thus the outer diameter of the bottom portion 3 can be accordingly dimensioned. The disclosed device 1 could be manufactured in any size to fit different applications. In addition, as discussed below in relation to FIGS. 4-7, the lower portion 3 may include annular ribs that extend radially outwardly from at least a portion of the lower portion. The annular ribs may be flexible, for example, and allow the lower portion 3 to be used in bottles with necks having slightly different inner diameters.

The upper portion 2 has an outer diameter that is larger than the inside diameter of the neck. In addition, the upper portion 2 comprises a flute 7 and a porous layer 6. The flute 7 extends from one side of a side wall 24 of the upper portion 2 and defines an opening with a top surface 21 of the upper portion 2. Fluid may exit the internal cavity 5 through the flute 7. The porous layer 6 is disposed adjacent the flute 7 and extends between the flute 7 and the internal cavity 5 such that liquid poured from the internal cavity 5 through the flute 7 passes through the porous layer 6. The porous layer 6 may include one or more openings defined in the upper portion 2 or may be a separate, porous material disposed within the upper portion 2.

The top surface 21 may be part of a cover 8 that is separately formed from the upper portion 2 and defines a space over at least a substantial majority of the porous layer 6, but not over the flute 7. The cover 8 may be removably affixed to the upper portion 2. For example, the cover 8 may threadingly engage a portion of the upper portion 2 or may include an annular ring that snap fits onto a portion of the upper portion 2. This configuration allows the user to separate the top part so that the contents, e.g., used cation exchange resin, of the internal cavity 5 can be removed and replenished. This can also allow the user to clean the internal surfaces of the device 1. In other embodiments, the cover 8 may be permanently affixed to the upper portion 2 or integrally formed therewith.

Further, a channel vent 9 is defined in the side wall 24 of the upper portion 2 and the lower portion 3 on a side substantially opposite from the flute 7 relative to a longitudinal axis that extends through the upper 2 and lower portions 3 of the device 1. The channel vent 9 is separated from the internal cavity 5 via an intermediate side wall portion 25. In particular, the channel vent 9 is a generally elongated channel that extends between a lower opening 22 defined adjacent the bottom surface 4b of the lower portion 3 and an upper opening 23 defined in the side wall 24 of the upper portion 2. The channel vent 9 allows air to enter the bottle when the liquid is being poured through the device 1 and out the flute 7.

In the embodiment shown in FIGS. 1-3, the lower portion 2 frictionally engages the internal side walls of the neck of the bottle. However, in other embodiments (not shown), the lower portion 3 may define one or more annular ribs that extend radially outwardly from at least a portion of an external surface of the side wall 24 of the lower portion 3 to help secure the device 1 in the neck of the bottle and prevent it from sliding out of the neck when pouring liquid contents of the bottle through the device 1. These ribs may be flexible or radially compressible to allow the lower portion 2 to be engaged in bottles having necks with different internal diameters. For example, one embodiment of ribs that may be used with device 1 is described below in relation to FIGS. 4-7.

In still another example (not shown), the lower portion 3 may define a smooth external surface and taper toward its bottom surface 4b. For example, in such an implementation, the diameter may increase from a smaller diameter adjacent the one or more openings 4a to a larger diameter axially above the bottom surface 4b approaching the upper portion 2. The larger diameter may be greater than the neck's internal diameter. In this embodiment, the lower portion 3 of the device 1 can be inserted into the neck to a point where the outer diameter of the lower portion 3 substantially equals the internal diameter of the bottle neck. This configuration can act to wedge the device 1 into the bottle's neck and prevent it from sliding out of the neck when pouring liquid contents of the bottle through the device 1.

In another embodiment (not shown), the upper portion 2 of the device 1 may be divided into two parts along a horizontal plane and the two parts can be configured such that they can be separated and reattached.

An effective amount of cation exchange resin and/or molecularly imprinted medium to remove the biogenic amines from a quantity of wine is disposed within the internal cavity 5. In certain embodiments, the effective amount of cation exchange resin and/or molecularly imprinted medium may be disposed in a cartridge or a sachet (e.g., like a tea bag) prior to disposing within the internal cavity 5. Separate cartridges and sachets containing said effective amount of cation exchange resin and/or molecularly imprinted medium are also disclosed herein. Such cartridges and sachets can be provided with the devices disclosed herein so that the devices can be refilled and reused. It is also contemplated that the cartridges or sachets, as disclosed herein, containing the cation exchange resin and/or molecularly imprinted medium can be inserted into the internal cavity 5 of the device 1. The cartridge or “tea-bag” can be configured so that they fit snugly within the device 1.

In still another exemplary embodiment (not shown), an internal surface of the elongated body of device 1 may define one or more ridges, such as annular or semi-annularly shaped ridges or an array of protrusions that extend into the internal cavity 5 that cause a turbulent flow of the liquid as it flows through the device 1.

The device 1 can be made from of a plastic material such as polypropylene or polyethylene and manufactured by injection molding, for example.

FIGS. 4-6 show another exemplary embodiment of a device 10 as disclosed herein. The device 10 includes a generally elongated body 13 having an upper portion 18 and a lower portion 19. These portions 18, 19 have an external surface 26 and an internal surface 27. The external diameter of the body 13 is substantially the same for at least a portion of the upper 18 and lower portions 19, and at least a portion of the lower portion 19 fits within the internal diameter of most commercially available bottles. Most bottles in commercial use for products such as wine have an internal diameter of about 16.36 mm to about 19.81 mm. Thus the diameter of the device 10 can be accordingly dimensioned. The disclosed device 10 could be manufactured in any size to fit different applications.

The body 13 includes a spout 11. The spout 11 is defined by one or more openings in a side wall 28 of the upper portion 18. In alternative embodiments (not shown), the spout 11 may include one or more openings in the side wall 28 and a flute that extends radially outwardly from the side wall 28. For example, the flute may be similar to the flute 7 described above in relation to FIGS. 1-3. In embodiments including the flute, the flute may be integrally formed with the side wall 28 or defined as part of a separate sleeve that fits around at least a portion of the upper portion 18 adjacent one or more openings defined therein.

In certain examples, the device 10 may include a cap that is configured to fit around the spout 11 and seal the contents of the bottle. In other examples (not shown), the spout is omitted and the liquid may flow out of one or more openings defined in the upper portion 18 of the body 13, such as, for example, in a top surface of the upper portion 18 or in the side wall 28.

The body 13 also includes a lip 12 that is extends radially outwardly from the upper portion 18 of the body 13. A lower surface 29 of the lip 12 is configured to securely fit on a top surface of the neck of the bottle 20. In the embodiment shown in FIGS. 4-6, the lip 12 has a frusto-conical cross-sectional shape with the wide, annular lower surface 29 adjacent the lower portion 19 and a side wall that slopes radially inwardly and axially upwardly toward the upper portion 18 from the lower surface 29.

In addition, one or more annular or semi-annular ribs 14 extends radially outwardly from an external surface of the side wall 28 of the body 13 and is integrally formed therewith. The ribs 14 are disposed on the lower portion 19 of the body 13 axially below the lip 12. The ribs 14 allow the device 10 to securely fit within the neck of the bottle 20. The ribs 14 are sufficiently flexible to accommodate a bottle having an internal diameter that is slightly smaller than an outer diameter of the ribs 14. For example, the ribs 14 may be formed of a flexible polymer material or rubber. The ribs 14 and lip 12 allow for a snug fit of the device 10 within the neck of a bottle so that the device 10 does not fall out of a bottle when pouring and so that the liquid inside the bottle does not leak out. In other embodiments (not shown), the external diameter of the body 13 can taper such that the external diameter at the lower portion 19 of the body 13 is smaller than the external diameter at the upper portion 18. In this way the device 10 can be inserted into the neck to the point on the body 13 where its diameter equals the internal diameter of the bottle neck and “wedges” the device 10 into the bottle neck so that it stays put during pouring.

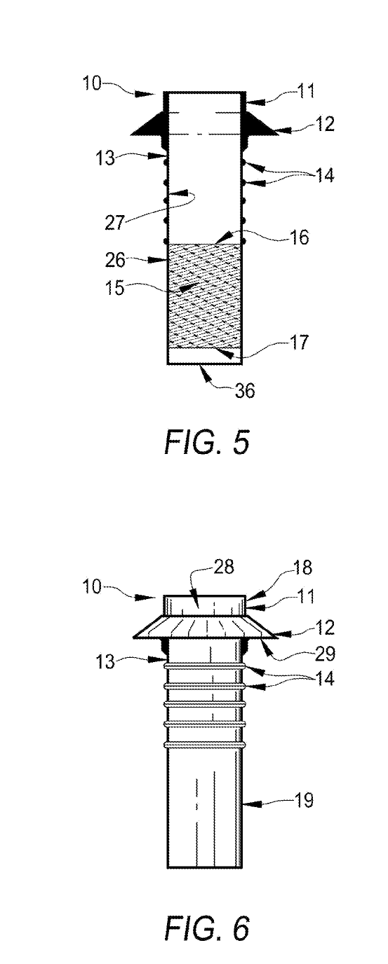

A cartridge 15 comprising a cation exchange resin or molecularly imprinted medium, as is detailed more herein, is disposed within the body 13. The cartridge 15 can be disposed near the lower portion 19 of the body 13 (as shown in FIGS. 4 and 5), near the upper portion 18, in between the lower 19 and upper portions 18, or through substantially the entire length of the body 13. In one aspect, the cartridge 15 can be removed from the body 13, e.g., it is removably affixed within the body. The cartridge 15 may fit tightly within the body and remain in place by tension or friction, or it may be held into place by complementary, engageable ridges or protrusions defined on an external surface of the cartridge 15 and an internal surface of the body 13, which allows removal and insertion of the cartridge 15 without prying or other undue force. In this way, the user can replace an old cartridge 15 for a new one and thereby replace the cation exchange resin or molecularly imprinted medium after one or several uses or after the cation exchange resin or molecularly imprinted medium is no longer useful, without replacing the entire device 10. In other aspects, the cartridge 15 can be permanently affixed within the body 13.

The cartridge 15 has a top surface 16 and a bottom surface 17, and optionally side walls, that are porous (liquid permeable) and allow the wine or other liquid to flow through the device 10, yet hold the exchange resin in place and prevent it from being poured out along with the wine or other liquid. The lower portion 19 of the body 13 defines one or more openings along a bottom surface 36 of the lower portion 19 to allow the wine or other liquid into the body 13 and the cartridge 15 so that the wine or other liquid can contact the cation exchange resin or molecularly imprinted medium.

The lower portion 19 of the body 13 adjacent the openings in the bottom surface 36 may also include a screen or other filter for removing fragments of cork and sediment. Such screens or filters may be cellulose, nylon, or polypropylene or other inert material and may have pore sizes of from about 105 to about 500 microns.

The length of the cartridge 15 should be long enough to contain an amount of cation exchange resin or molecularly imprinted medium suitable to sufficiently remove the amines from a given volume of wine or other liquid. For a 750 mL bottle of wine, the amount of cation exchange resin can be from about 0.5 g to about 10 g; thus the length of the cartridge, given the diameter of the body 13, should be sufficiently long to accommodate the amount of cation exchange resin. The amount of molecularly imprinted medium would be similar to or less than the amount of cation exchange resin needed. Likewise, the length of the body 13 is sufficiently long to accommodate the length of the cartridge 15. For an average bottle of wine, the length of the cartridge 15 can be from about 3 cm to about 30 cm long, though variations from changes in diameter and volume can be accounted for. Based on the volume of cation exchange resin or molecularly imprinted medium used, the length and diameter of the cartridge can be adjusted accordingly.

The internal surface 27 of the lower portion 19 may be generally smooth along the edge (as shown in the figures). In other embodiments (not shown), it is contemplated that an internal surface of the body 13 and/or an external surface of the cartridge 15 may be corrugated, to increase the contact of the wine or other liquid with the cation exchange resin or molecularly imprinted medium. Similarly, in other embodiments (not shown), at least a portion of the upper portion 18 of the body 13 can be curved to lengthen the path of contact for the wine and cation exchange resin or molecularly imprinted medium.

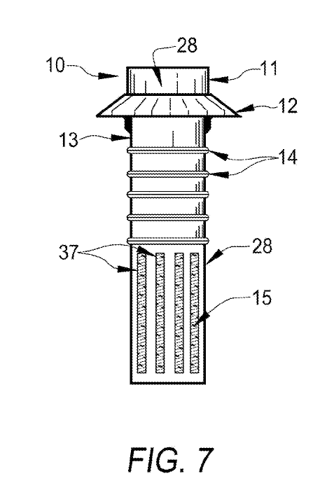

The embodiment shown in FIG. 7 is similar to the embodiment shown in FIGS. 4-6. However, in this embodiment, the lower portion of the body 13 defines one or more slits 37 or shaped openings within the side wall 28. The walls of the cartridge 15 are at least partially porous, and the cartridge 15 is disposed within the lower portion 19 adjacent the one or more slits 37 so wine or other fluid can flow through the slits 18 and into the cartridge 15 to contact the cation exchange resin or molecularly imprinted medium. An advantage of this embodiment is that more wine or other liquid can contact the ionic exchange resin or molecularly imprinted medium in a shorter amount of time. Alternative embodiments may include disposing the cartridge 15 completely axially above the slits 18 or other opening(s) in the body 13 or partially above the slits 18 or other opening(s). Such alternative embodiments may allow a part of the cartridge 15 to be directly accessed via the slits 18 or openings.

In other exemplary embodiments (not shown), the device 10 can comprise one or more additional cartridges above and/or below cartridge 15. These additional cartridges can comprise other materials that filter or otherwise alter the wine or other liquid being poured through the device 10. For example, an additional cartridge can contain activated charcoal to remove sediment or impurities, weakly acidic or basic exchange resins to alter pH or remove minerals, cellulose or nylon to filter particulates, and the like. These additional cartridges can be permanently affixed to the body 13 or removable from the body 13.

In still another exemplary embodiment (not shown), the device 10 need not contain a cartridge 15, but instead, is filled with the cation exchange resin and/or molecularly imprinted medium. Alternatively, sachets containing an effective amount of cation exchange resin and/or molecularly imprinted medium can be provided with device 10 so that the device can be refilled and reused.

The body 13, spout 11, lip 12, and/or ribs 14, can be made of a plastic material such as polypropylene or polyethylene and manufactured by injection molding. The external surface 26 of the body 13 may also include handles or other protrusions that the user can use to grip or leverage the device 10 when twisting the device 10 into a bottle 20 (not shown).

In other exemplary embodiments (not shown), a cylindrical tube may be disposed inside or through the body 13. For example, the tube may be disposed or formed in the side wall 28 of the body 13 substantially opposite the spout 11 relative to a longitudinal axis that extends through the body 13 between the upper portion 18 and the lower portion 19. The cylindrical tube may extend from the external surface 26 of the upper portion 18 of the body 13, through the body 13, and out of the external surface 26 of the lower portion 19 of the body 13 to allow air into the bottle 20 more quickly for faster pouring. In another embodiment, the tube may extend through at least a portion of the cartridge 15 but is not in liquid communication with the liquid in the body 13 or cartridge 15.

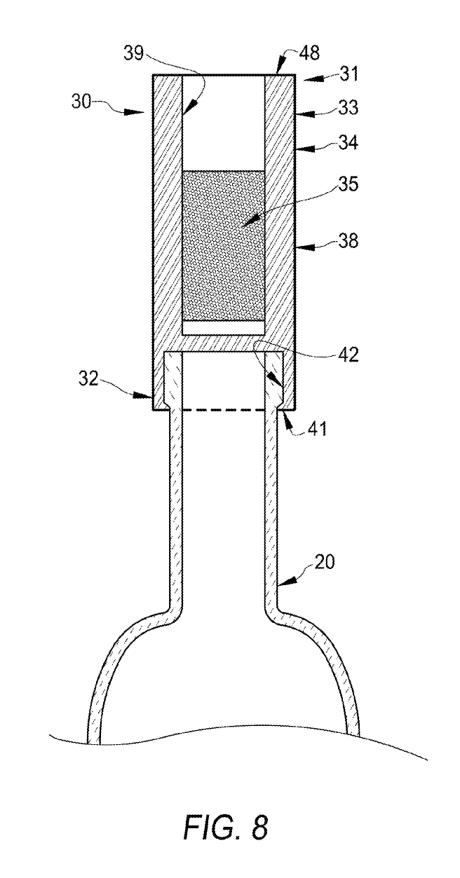

FIG. 8 shows a device 30 according to yet another implementation that is attachable to an outside surface of the neck of a standard bottle 20. Again, it is to be understood that there are many different bottle shapes currently in use for wine and other liquids, and the disclosed devices are intended to be usable in most if not all such bottle designs. The exemplary embodiment shown in FIG. 8 is illustrative of these various designs.

The device 30 includes a generally elongated body 33 having an upper portion 34, a lower portion 32, an external surface 38, and an internal surface 39. The lower portion 32 defines a neck-receiving channel 42 axially above an annular bottom surface 41 of the lower portion 32. The neck-receiving channel 42 is configured for being urged in a radially outward direction to receive the neck of the bottle and biasing itself radially inwardly against an upper portion of the neck. An internal diameter of the neck-receiving channel 42 is greater than an internal diameter of the annular bottom surface 41 of the device 30 and is sized to engage (e.g., is slightly larger or larger than) the external diameter of the upper portion of the neck of most commercially available bottles (as shown). The engagement of the neck-receiving channel 42 around the upper portion of the neck of the bottle allows the device 30 to securely fit to the bottle's neck. The lower portion 32 can be integrally with the body 33 or it can be a separately formed sleeve configured to fit around and engage the body 33 (not shown).

In addition, the annular bottom surface 41 is configured for engaging a portion of the neck of the bottle that has a reduced external diameter as compared to the upper portion of the neck. In other embodiments (not shown), the annular bottom surface 41 and the neck-receiving channel 42 have substantially the same internal diameter.

Integrally formed with the body 33 (or as a separate sleeve on the body) is a spout 31. The spout 31 is defined by one or more openings in a side wall 48 of the upper portion 34. In alternative embodiments (not shown), the spout 31 may include one or more openings in the side wall 48 and a flute that extends radially outwardly from the side wall 48. For example, the flute may be similar to the flute 7 described above in relation to FIGS. 1-3. In embodiments including the flute, the flute may be integrally formed with the side wall 48 or defined as part of a separate sleeve that fits around at least a portion of the upper portion 34 adjacent one or more openings defined therein.

In certain examples, the device 30 may include a cap (not shown) that is configured to fit over or engage with the spout 31 to seal the contents of the bottle. In other examples (not shown), the spout is omitted and the liquid may flow out of one or more openings defined in the upper portion 34 of the body 33, such as, for example, in a top surface of the upper portion 34 or in the side wall 48.

A cartridge 35 containing a cation exchange resin or molecularly imprinted medium, as is detailed more herein, is disposed within the body of the device 30. The cartridge 35 can be disposed adjacent the lower portion 32 of the body 33 (as shown in the figures), adjacent the upper portion 34, or through substantially the entire length of the body 33. In one implementation, the cartridge 35 can be removed from the body 33, e.g., it can fit tightly within the body and remain in place by tension or friction, or it can be held into place by complementary, engaging ridges or protrusions defined on an external surface of the cartridge 35 and an internal surface of the body 33, which allow the cartridge 35 to come out of the tube with minimal prying or force. In this way, the user can replace an old cartridge 35 for a new one and thereby replace the cation exchange resin or molecularly imprinted medium after one or several uses or after the cation exchange resin or molecularly imprinted medium is no longer useful. In other implementations, the cartridge 35 can be permanently affixed to the body 33.

The length of the cartridge 35 should be long enough to contain an amount of cation exchange resin or molecularly imprinted medium suitable to sufficiently remove the amines from a given volume of wine or other liquid. For a 750 mL bottle of wine, the amount of cation exchange resin can be from about 0.5 g to about 10 g; thus the length of the cartridge, given the diameter of the body 33, should be sufficiently long to accommodate the amount of cation exchange resin. The amount of molecularly imprinted medium needed would be similar or less than the amount of cation exchange resin. Likewise, the length of the body 33 should be sufficiently long to accommodate the length of the cartridge 35. For an average bottle of wine, the length of the cartridge 35 can be from about 3 cm to about 10 cm long, though variations from changes in diameter and volume can be accounted for. Based on the volume of cation exchange resin or molecularly imprinted medium used, the length and diameter of the cartridge can be adjusted accordingly. The body 33 is longer than the cartridge 35 within it.

It is also contemplated that at least a portion of the internal surface of the elongated body 33 and/or at least a portion of the external surface of the cartridge 35 can be corrugated or include protrusions, to increase the contact of the wine with the cation exchange resin. Similarly, at least a portion of the body 33 can be curved to lengthen the path of contact for the wine and cation exchange resin.

In another exemplary embodiment (not shown), the device 30 can comprise one or more additional cartridges disposed above and/or below cartridge 35. These additional cartridges can comprise other materials that filter or otherwise alter the wine or other liquid being poured through the device 30. For example, an additional cartridge can contain activated charcoal to remove sediment or impurities, acidic or basic exchange resins to alter pH or remove minerals, cellulose, nylon or other filter material. These additional cartridges can be permanently affixed to the body 33 or removable from the body 33.

In still another exemplary embodiment, the device 30 need not contain a cartridge 35, but instead, is filled with the cation exchange resin and/or molecularly imprinted medium. Sachets containing an effective amount of cation exchange resin and/or molecularly imprinted medium can be provided with device 30 so that the device can be refilled and reused.

The body 33 can be made of a plastic material such as polypropylene or polyethylene and manufactured by injection molding, for example.

In other exemplary embodiments (not shown), a cylindrical tube may be disposed inside or through the body 33. For example, the tube may be disposed or formed in the side wall 48 of the body 33 substantially opposite the spout 31 relative to a longitudinal axis that extends through the body 33 between the upper portion 34 and the lower portion 38. The cylindrical tube may extend from an external surface of the upper portion 34 of the body 33, through the body 33, and out an external surface of the lower portion 38 of the body 33 to allow air into the bottle 20 more quickly for faster pouring. In another embodiment, the tube may extend through at least a portion of the cartridge 35 but is not in liquid communication with the liquid in the body 33 or cartridge 35.

Cartridge

Also, disclosed herein are cartridges, such as cartridges 15, 35, that contain an ionic exchange resin. The cartridge can be generally elongated (e.g., cylindrically shaped) and can be configured so as to fit within the internal cavity 5 of device 1, or the body 13, 33 of devices 10, 30, respectively. At least the top and bottom of the cartridge are porous such that the wine or other liquid can pass through the cartridge while keeping the cation exchange resin or molecularly imprinted medium contents of the cartridge remain inside the cartridge. At least a portion of the side walls of the cartridge may be porous as well. The cartridges may include walls made of a generally rigid material. The cartridge can define a single chamber in which cation exchange resin or molecularly imprinted medium is disposed. Alternatively, the cartridge can define multiple chambers, each with the same or different ion exchange resins and/or molecularly imprinted media. Still further, the cartridge can define multiple chambers where at least one contains a cation exchange resin or molecularly imprinted medium and at least another contains other filtering material like charcoal, cellulose, nylon and the like. In implementations in which the body provides structural support to the cartridge, the cartridge may instead have flexible walls, e.g., like a porous bag or “tea-bag”, or at least a portion of the walls may be made of a flexible material.

The size of the cartridge should be sufficiently large so as to accommodate an amount of cation exchange resin or molecularly imprinted medium effective for removing biogenic amines from a given volume of wine or other liquid. In general about 1 g of cation exchange resin is suitable for removing amines in 100 mL of wine or other liquid to base line levels. Correspondingly, 7.5 g of cation exchange resin is suitable for 750 mL of wine or other liquid and so forth. The amounts of molecularly imprinted medium needed would be similar. Given the volume of the liquid or size of the bottle, a suitable range of cation exchange resin or molecularly imprinted medium can be determined, which leads to a corresponding volume of resin that cartridge should accommodate. The length and diameter of the cartridge can be sized accordingly to accommodate the desired volume of resin.

In an exemplary embodiment, the cartridge can be used alone, without the device, such as the devices described above in relation to FIGS. 1-8. In such an embodiment, the cartridge can simply be dropped into the bottle or glass. A string can be attached to the cartridge so that it can be retrieved (e.g., like a tea bag). Alternatively, the cartridge can be attached to a rod so that the cartridge can be retrieved. The disclosed cartridges can also be used on other filtering devices such as those disclosed in U.S. Pat. Nos. 5,417,860, 6,165,362, 6,153,096, which are each incorporated by reference herein in their entireties for their teachings of liquid filtering devices.

Also disclosed herein is an intermediary container that comprises a sufficient amount of cation exchange resin and/or molecularly imprinted medium to remove or reduce amines from wine or other liquids. The intermediary containing can be decanter that contains within its volume a cation exchange resin or molecularly imprinted medium. There are a variety of decorative decanters or other similar vessels for holding wine or other liquids. These can be modified to contain one or more cartridges, e.g., on the bottom, along the neck or walls, that house a sufficient amount of cation exchange resin or molecularly imprinted medium. An example is shown in FIG. 12.

### Methods

Disclosed herein is a method for removing or reducing one or more biogenic amines from wine or other liquid at the point of use. These methods can use the devices and cartridges disclosed herein or use other columns or filters containing cation exchange resins. As can be seen from the molecular structures in Table 1, biogenic amines vary significantly in size and structure, but one of their common features is that they all have one or more primary amine group connected to the rest of the molecule by an aliphatic hydrocarbon chain. As such, the disclosed methods and devices involve the use of a cation exchange resin in its hydrogen form to remove these amines from wine or other liquids. The methods disclosed herein comprise contacting a wine or other liquid at the point of use with a cation exchange resin for a time sufficient to remove one or more amines from the wine or other liquid. It is noted during the production of wine, there are no biogenic amines since such amines are generated after the wine is prepared, bottled, and stored. Thus, use of cation exchange resins during the production of wine would not have removed biogenic amines.

The general reaction for removing the amines (RNH₂) by ion exchange is shown in the equation below.

Resin-CO₂H+RNH₂→Resin-CO₂⁻+RN⁺H₃

Resin-SO₃H+RNH₂→Resin-SO₃⁻+RN⁺H₃

The general reaction for removing ammonium salts (e.g., Ac⁻RNH₃⁺) by ion exchange is shown in the equation below.

Resin-SO₂H+Ac⁻RN⁺H₃→Resin-SO₂⁻+RN⁺H₃+AcH

### Ion Exchange Resin

Ion exchange is the reversible interchange of ions between a solid (ion exchange material) and a liquid in which there is no permanent change in the structure of the solid. Ion exchange is used in water treatment and also provides a method of separation in many non-water processes. It has special utility in chemical synthesis, medical research, food processing, mining, agriculture and a variety of other areas.

Ion exchange resins have been used to treat wine during the manufacturing process, but not at the point of use. In particular, treating wine before bottling with cation exchange resins in the hydrogen form has been alleged to reduce potassium bitartrate haze, prevent copper and iron turbidity, stabilize against microbial infection, and increase in bouquet (R. Kunin, “AmberHi-Lite, Fifty Years of Ion Exchange,” Tall Oaks Publishing, July 1996). Phenolic cation exchange resins have been used for similar purposes, but with the caveat that the amount of wine treated is limited by the resulting decrease in pH. Id. Small particle size carboxylic resins have also been used to pre-concentrate biogenic amines for analytical purposes. The method also picked-up some amino acids and saccharides (Lethonen, “Determination of Amines and Amino Acids in Wine—a Review,” Am. J. Enol. Vitic. 47(2):127-133 (1996)).

To use ion exchange at the point of use for the removal of biogenic amines, three parameters should be considered: type of resin, capacity (i.e., the amount of resin required to remove the amines present in a given volume of liquid), and kinetics (i.e., how long it takes to remove the amines from the liquid). These parameters have different levels of importance at the point of use stage than at the manufacturing stage. Thus, whether a given resin or device may work for one purpose at one stage of the process would not directly translate into whether the resin can be used at another point, under different conditions, and for a different purpose.

Type of Resin

The structure and porosity of an ion exchange resin are determined principally by the conditions of polymerization of the backbone polymer. Porosity determines the size of the species (molecule or ion) that may enter a specific structure and its rate of diffusion and exchange. There also is a strong interrelationship between the equilibrium properties of swelling and ionic selectivity. For example, a conventional gel type, styrenic ion exchanger is built on a matrix prepared by co-polymerizing styrene and divinylbenzene (DVB). In these systems, porosity is inversely related to the DVB cross-linking. Suitable resins for use herein are such gel resins. Gel resins exhibit microporosity with pore volumes typically up to 10 or 15 Å.

In other examples, the resin is a macroporous (macroreticular) ion exchange resin, which have pores of a considerably larger size than those of the gel type resins with pore diameters up to several hundred Å. Their surface area can reach 500 m²/g or higher. Macroporous polymers are generally highly cross-linked and therefore exhibit little volume change (swelling).

Suitable cation exchange resins for use herein are food grade. The term “food grade matrix” is any material that can form a matrix and that is cleared by the U.S. Food and Drug Administration as a Secondary Direct Food Additive under 21 C.F.R. §173. Sections 5-165 of 21 C.F.R. §173 provide representative examples of materials useful as the food grade matrix as well as permissible amounts of impurities to be considered a food grade matrix useful herein. For example, the material used to produce the food grade matrix comprises less than 10%, less than 8%, less than 6%, less than 4%, or less than 2% by weight nonpolymerizable impurities.

In one aspect, the food grade matrix comprises an acrylate-acrylamide resin (173.5), a polyacrylamide resin (173.10), an ion exchange resin (173.25), a perfluorinated ion exchange membrane (173.21), an ion exchange membrane (173.20), a molecular sieve resin (173.40), polymaleic acid or the sodium salt thereof (173.45), polyvinylpolypyrrolidone (173.50), polyvinylpyrrolidone (173.55), dimethylamine-epichlorohydrin copolymer (173.60), chloromethylated aminated styrene-divinylbenzene resin (173.70), sodium polyacrylate (173.73), or sorbitan monooleate (173.75), where the number in parenthesis is the federal registration section number that provides information with respect to the requirements of the material to be a secondary direct food additive. In a preferred aspect, the resin is a sulfonated copolymer of styrene and divinylbenzene, as described in 21 C.F.R. §173.25(a)(1)).

In another aspect, the food grade matrix comprises a copolymer of divinylbenzene. For example, the food grade matrix comprises a copolymer of (1) divinylbenzene and (2) acrylic acid, methacrylic acid, methyl acrylate, methyl methacrylate, ethyl vinyl benzene, or styrene. Title 21 C.F.R. §173.65 provides the requirements for the use of divinylbenzene copolymers as a secondary direct food additive. For example, the divinylbenzene copolymer must have at least 79 weight percent divinylbenzene and no more than 4 weight percent nonpolymerizable impurities. Examples of divinylbenzene copolymers useful herein as food grade matrices include, but are not limited to, Amberlite™ XAD resins which are crosslinked, macroporous polystyrene/divinylbenzene copolymers.

The cation exchange resins are functionalized with chemical group that can chemically react with primary amines. Generally, this is a carboxylic acid group such as —CO₂H or a sulfonic acid group such as —SO₃H.

Capacity

Ion exchange capacity can be expressed in a number of ways. Total capacity, i.e., the total number of sites available for exchange, is normally determined after converting the resin by chemical regeneration techniques to a given ionic form. The ion is then chemically removed from a measured quantity of the resin and quantitatively determined in solution by conventional analytical methods. Total capacity is expressed on a dry weight, wet weight, or wet volume basis. The water uptake of a resin and therefore its wet weight and wet volume capacities are dependent on the nature of the polymer backbone as well as the environment in which the sample is placed.

Operating capacity is a measure of the useful performance obtained with the ion exchange material when it is operating in a column under a prescribed set of conditions. It is dependent on a number of factors including the inherent (total) capacity of the resin, the level of regeneration, the composition of solution treated, the flow rates through the column, temperature, particle size and distribution.

In Table 2, the maximum amounts of various biogenic amines found in wines prepared using different processes are shown (milliequivalents of amine groups per liter of wine). Adding all the values gives a “worst case scenario” total amine content of 0.82 meq/L. Using a volume capacity of 3.5 meq/mL for a poly(methacrylic acid) resin (such as Rohm and Haas' IRC-50) and 1.4 meq/g for a macroporous (fast kinetics) sulfonic resin (such as Thermax's T-84), about one gram or less of resin is sufficient to remove all amines from 1 L of wine. Extrapolation to other volumes of wine or other liquids can accordingly be made. Accordingly, as disclosed herein the methods and devices can use from about 0.5 g to about 10 g of cation exchange resin. For example, the cartridges disclosed herein can comprises from about 0.5 g to about 10 g, from about 1 to about 5 g, from about 5 to about 10 g, from about 2 to about 4 g, from about 1 to about 5, from about 0.5 to about 2 g of cation exchange resin. In other examples, the cartridges disclosed herein can comprise about 0.5, 1, 1.5, 2, 2.5, 3, 3.5, 4, 4.5, 5, 5.5, 6, 6.5, 7, 7.5, 8, 8.5, 9, 9.5, or 10 g of cation exchange resin, where any of the stated values can form an upper or lower endpoint of a range.

TABLE 2
Highest levels of various biogenic amines encountered in wines

| | MAX. AMT. | MW | |
|---|---|---|---|
| AMINE | (mg/L) | (Daltons) | MAX. meq. -NH₂/L |
| Putrescine | 11.07 | 88 | (11.07 × 2)/88 = 0.25 |
| Cadaverine | 2.09 | 102 | (2.09 × 2)/102 = 0.40 |
| Ethylamine | 3.07 | 45 | 3.07/45 = 0.07 |
| Methylamine | 1.36 | 31 | 1.36/31 = 0.04 |
| Tyramine | 2.37 | 137 | 2.37/137 = 0.02 |
| Histamine | 4.89 | 111 | 4.89/111 = 0.04 |
| TOTAL | | | 0.82 |

Kinetics

Short times are desirable for removing amines at the point of use with cation exchange resins packed in a column, device or cartridge. On method involves contacting a poured glass of wine or other liquid with a cartridge containing a cation exchange resin (e.g., either attached to a rod or sting as in a tea bag), rather than pouring the content of the bottle through a cartridge into the glass.

Another method for increasing kinetics and is to decrease the particle size of the cation exchange resin. Suitably small particles sizes are below 1680 microns, e.g., from 500 to 1410 microns. Smaller sizes can also be used such as 10 micron, 15 micron, 25 micron, 37 micron, 44 micron, 53 micron, 63 micron, 74 micron, 88 micron, 105 micron, 125 micron, 149 micron, 177 micron, 210 micron, 250 micron, 297 micron, 354 micron, 400 micron, 500 micron, 595 micron, 707 micron, 841 micron, 100 micron, 119 micron, 1410 micron, or 1680 micron, where any of the stated values can form an upper or lower endpoint of a range. Alternatively, resins with larger particle sizes (e.g., from 1680 to 6730 micron) can be ground down to small sizes.

### Molecularly Imprinted Medium

In alternative embodiments the cartridge is filed with a polymer molecularly imprinted with the —CH₂—CH₂—NH₂ moiety common to all biogenic amines (except methylamine). Molecular imprinting is a technique, which creates a polymer (or similar) matrix with binding sites for specific molecules based on a combination of recognition mechanisms including size, shape, and functionality. Molecular imprinting has become increasingly recognized as a powerful technique to produce synthetic polymers that contain tailor-made recognition sites for binding specific target molecules. The non-covalent imprinting and recognition principle is based on the concepts of molecular “keys” and polymeric “locks.” In principle, the imprinted sites would specifically recognize only the template molecules. Consequently a number of biomedical applications in the life sciences have been enabled by molecularly imprinted media (MIMs), including chromatographic separation, drug delivery, solid-phase extraction, diagnostic devices and biosensors. As disclosed herein, a molecularly imprinted medium is used in the cartridges disclosed herein or in a column to remove biogenic amines from wine or other liquids.

Molecularly imprinted media are described in the following patents and publications: U.S. Pat. No. 5,110,833 to Mosbach; U.S. Pat. No. 5,821,311 to Mosbach et al; U.S. Pat. No. 5,858,296 to Domb; U.S. Pat. No. 5,872,198 to Mosbach et al.; U.S. Pat. No. 6,638,498 to Green et al.; Mosbach, K. et al, “The Emerging Technique of Molecular imprinting and Its Future Impact on Biotechnology”, Biotechnology, vol Feb. 14, 1996, pp 163-170; G. Wulff. “Molecular Imprinting in Cross-Linked Materials with the Aid of Molecular Templates—A Way towards Artificial Antibodies” Angew. Chem. Intl. Ed. Engl., 34, 1812-1832 (1995); P. Hollinger, et al., “Mimicking Nature and Beyond” Trends in Biochemistry, 13(1), 79 (1995); Haupt, K., Mosbach, K. Trends Biotech, 16, 468-475 (1997); Davis et al, “Rational Catalyst Design via Imprinted Nanostructured Materials” Chem. Mater. 8 (1996) pp 1820-1839. and Wulff. G. et al, “Enzyme models Based on Molecularly Imprinted Polymers with Strong Esterase Activity” Angew. Chem. Int. Ed. Engl., 36 1962 (1997). Each of these references in incorporated by reference herein in their entireties for their teachings of molecularly imprinted media and methods for their preparation.

Molecular imprinting involves mixing a functional monomer capable of subsequent co-polymerization into a matrix, and the target molecule in solution and facilitating arrangement/binding of the functional monomer to the print molecules with a variety of possible interactions. After adding a cross-linking agent, a reaction is initiated via physical or chemical means inducing co-polymerization of the monomer and the cross-linker into a matrix. Then, the print molecules are removed by a variety of extraction processes, thereby leaving “molds” (a.k.a., binding sites complementary in shape, size, and functionality to the target/template molecule) in the matrix that can later entrap/re-recognize the “target” molecule (a.k.a., the print molecule). Each “mold” or cavity can be configured to capture the entire molecule or a portion thereof, e.g., a terminal end or a (or several) functional group(s). Also, the matrix can physically trap the target molecule, and can optionally employ a wide variety of binding types including but not limited to ionic, electrostatic, covalent, hydrogen, or van der Waals binding. By creating such a matrix specifically tailored for biogenic amines, these amines will be selectively remove from the wine or other liquid without affecting other constituents of the liquid.

There are two main approaches to molecular imprinting, though a wide variety of modifications and combinations have been published: (i) the covalent approach pioneered by Wulff and Sarhan, and (ii) the non-covalent approach initially developed by Arshady and Mosbach. Covalent imprinting uses templates, which are covalently bound to one or more polymerizable functional monomer groups. After polymerization, the template bonds to the matrix are cleaved, and the functionality left in the binding site is capable of binding the target molecule by re-establishment of a covalent bond. The advantage of this approach is that the functional groups are only associated with the template site.

Non-covalent imprinting based on non-covalent interactions such as but not limited to H-bonding, ion-pairing, and dipole-dipole interactions is also possible, as this approach is readily adaptable and facilitates rapid synthesis, provides close resemblance to the molecular recognition mechanisms of natural receptors, and benefits from the availability of substantial functional monomer libraries reported in literature.

Semi-covalent imprinting attempts to combine the advantages of the covalent and the non-covalent approach. As the template is covalently bound to a polymerizable functional monomer group, the functionality which is recovered after cleavage of the template should only be found in the binding site. However, re-binding takes place via semi- or non-covalent interactions. In stoichiometric non-covalent imprinting, the complex between functional monomer and template is strong enough to ensure that the equilibrium lies well on the side of the complex, therefore ensuring that it retains its integrity during the polymerization process; this can usually be ensured if the association constant (Kₐ) for the template-monomer interaction is greater than or equal to 10³ M⁻¹.

MIMs can be prepared as bulk polymer monoliths followed by mechanical grinding and sieving, thereby providing small (milli- to micrometer-sized) particles. Grafting approaches have also been applied, and electropolymerization procedures have been used to build up layers of e.g., acrylamide-based MIMs at ISFET (ion-sensitive field effect transistor) surfaces. Alternatively, a MIM material shaped as regular or irregular particle may be incorporated in thin layer or membrane serving as a structural scaffold coated at the device surface.

In exemplary embodiments, the cartridges disclosed herein or columns can comprise a non-covalent molecularly imprinted media. There are a number of monomers that can be used for the molecular imprinting, for example, acrylic acid, acrylamide, agarose, methacrylic acid, trifluoro-methacrylic acid, 4-vinylbenzoic acid, itaconic acid, 4-vinylbenzyl-iminodiacetic acid, 2-acrylamido-2-methyl-1-propane sulphonic acid, 1-vinylimadazole, 2-vinylpyridine, N,N-diethylaminoethyl methacrylate, styrenesulfonic acid, vinyl pyrrolidone, vinylimidazole, 4(5)-vinylimidazole, 3-acrylamidopropyltrimethylammonium chloride, styrene, 2-(methacryloyloxy)ethyl phosphate, styrene sulfonic acid, and mixtures thereof. The cross-linking monomer is responsible for mechanical and thermal stability of the polymer. It fixes the pre-polymerization complex in its position, yet provides sufficient porosity to easily release the template after the imprinting process, giving access to the target for rebinding. Hence, template leaking from the polymer should be low, and the polymer backbone should provide sufficient micro-, macro-, and meso-channels for the target to rapidly diffuse to the binding site. Examples of cross-linkers include divinylbenzene, trivinylcyclohexane, N,N′-methylene-bisacrylamide, N,N′-phenylene-bisacrylamide, 2,6-bisacrylamidopyridine, ethylene glycol methacrylate, ethylene glycol dimethacrylate, pentaerythritol triacrylate, pentaerythritol trimethacrylate, pentaerythritol tetraacrylate, trimethylolpropane trimethacrylate, and mixtures thereof. Generally, the more polymerizable groups per cross-linker the more rigid, and specific, the resulting imprinted medium.

In order to facilitate (initiate) the cross-linking (polymerization) of the monomer-print molecule admixture to form the imprinted medium, heat, radiation, or chemical initiation can be utilized depending on the selected materials. A number of different photo- and/or thermolabile initiators can be used such as 2,2′-azobis-(2,4-dimethylvaleronitrile) (ABDV), azobis-(isobutyronitrile) (AIBN), and benzoyl peroxide (BPO).

As an exemplary embodiment, a suitable MIM can be prepared by a non-covalent imprinting approach in aqueous solution using methacrylic acid or styrene sulfonic acid as the functional monomer and ethylene glycol dimethacrylate as the crosslinker. One more of the biogenic amines shown in Table 1 can be used as the template. Polymer precursors (i.e., monomers and an initiator) can be combined with the template in a solution for a time to ensure equilibration of non-covalent associations between templates and monomers. The solution can then be placed in an oven to initiate free radical thermal polymerization. The resulting polymers can be sieved, washed, and dried.

It is contemplated herein that the molecularly imprinted media can be used in place or in addition to the cation exchange resin in the disclosed devises and methods above.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures and other reaction ranges and conditions that can be used to optimize the product purity and yield obtained from the described process. Only reasonable and routine experimentation will be required to optimize such process conditions.

### Example 1: pH Vs. Time Curves as a Method for Determining the Removal Efficiency and Rate of Removal of Amine from Aqueous Phases

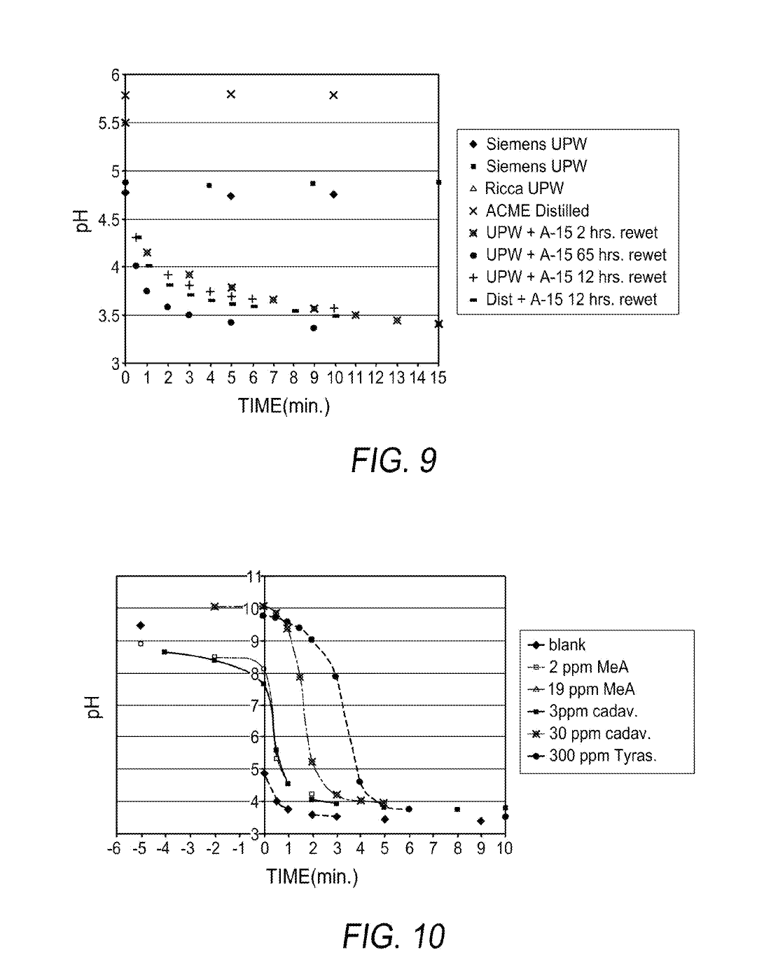

This set of experiments determined the “baseline” values of changes in pH over time of aqueous phases (both ultrapure water (UPW) and distilled water) upon the addition of an ion exchange resin. The experiments were performed by adding one gram of resin (dry base) to water after rewetting the resin in water for various amounts of time. The results obtained using Amberlyst 15, a strong acid (sulfonic) ion exchange resin of large particle size (from about 0.5 to about 1.2 mm particle diameter) are summarized in FIG. 9.

As the results in FIG. 9 show, stable pH is observed over time for the various grades of water used (UPW and distilled). Upon addition of 1 g of resin (dry basis, rewetted) to the water, a drop of pH is observed with final stabilization at about pH 3.5 in 5 to 10 min. The longest rewet time gave the fastest pH drop.

### Example 2: Amines Removal from Ultrapure Water

This set of experiments used three amines (methyl amine (MeA), cadaverine (cadav.), and tyrasine (tyras.), which were selected because they covered a range of size and hydrophobicity. Methylamine is the smallest and the most hydrophilic of the three. Cadaverine is of intermediate size and hydrophilicity. Tyrasine is the largest and most hydrophobic of the three.

The pH changes over time observed upon addition of 1 gram of Amberlyst 15 dry (A-15) to 100 mL of the amine solutions at various concentrations are provided in FIG. 10. For Methyl amine and cadaverine, low concentrations were used to mimic the levels encountered in wine (a few ppm). For tyrasine, higher concentrations were required in order to detect a measurable drop in pH upon addition of the ion exchange resin to the amine solution.

One gram of resin in 100 mL of amine solution was a sufficient amount of resin required to effectively remove the amines to the “baseline” level from Example 1. In other words, about 7.5 g of resin would effectively remove biogenic amines from a 750 mL bottle of wine.

Where the time required to remove the amines is concerned, at the typical concentration of a few ppm encountered in wine, the data in FIG. 10 shows that, in a stirred batch mode, about 2 minutes are required to reach the “baseline” of pH 4. It is also observed that the time required to reach the baseline increases as the amine concentration in the solution increases. Presumably, diffusion to ion exchange sites deeper into the resin beads is required at the higher concentrations. Considering a 30 mL “bottle-top” cartridge, corresponding to a 10 mL void volume of packed ion exchange resins, a 2 minute contact time would translate to a flow rate of 5 mL/min. One would also have to wait for two minutes before any wine comes out of the cartridge.

### Example 3: Effect of Ethanol

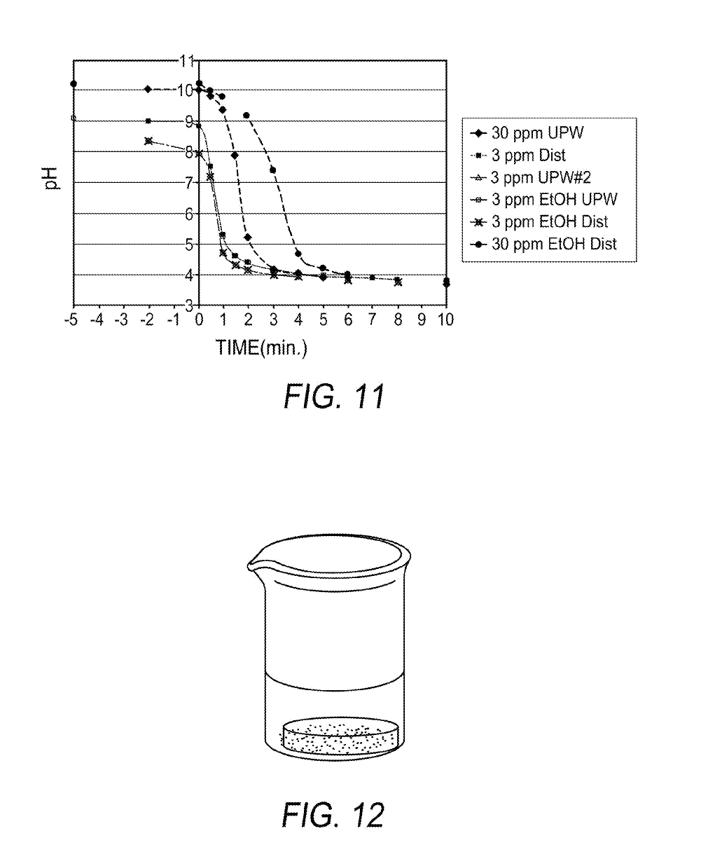

The impact of ethanol on the efficacy and rate of removal of amines from aqueous solutions was obtained using 10% by weight ethanol in water and cadaverine as the amine model. The same conditions and resin used in Example 2 were used here. The results, presented in FIG. 11, show that, although the presence of alcohol seems to slow down the amine pick-up rate at higher (30 ppm) concentration, no such effect is observed at the concentrations typically encountered in wine (a few ppm).

The materials and methods of the appended claims are not limited in scope by the specific materials and methods described herein, which are intended as illustrations of a few aspects of the claims and any materials and methods that are functionally equivalent are within the scope of this disclosure. Various modifications of the materials and methods in addition to those shown and described herein are intended to fall within the scope of the appended claims. Further, while only certain representative materials, methods, and aspects of these materials and methods are specifically described, other materials and methods and combinations of various features of the materials and methods are intended to fall within the scope of the appended claims, even if not specifically recited. Thus a combination of steps, elements, components, or constituents can be explicitly mentioned herein; however, all other combinations of steps, elements, components, and constituents are included, even though not explicitly stated.

What is claimed is:

1. A method of removing or reducing a biogenic amine from wine at the point of use, comprising: contacting wine comprising a biogenic amine with an effective amount of a cation exchange resin or a molecularly imprinted medium selective for the moiety CH₂—CH₂—NH₂ for a sufficient time to remove or reduce the biogenic amine from the wine.

2. The method of claim 1, wherein the cation exchange resin comprises sulfonic acid groups.

3. The method of claim 1, wherein the cation exchange resin comprises carboxylic acid groups.

4. The method of claim 1, wherein the cation exchange resin is a gel resin.

5. The method of claim 1, wherein the cation exchange resin is a macroreticular resin.

6. The method of claim 1, wherein the cation exchange resin comprises a copolymer divinylbenzene and acrylic acid, methacrylic acid, methyl acrylate, methyl methacrylate, ethyl vinyl benzene, or styrene.

7. The method of claim 1, wherein the cation exchange resin comprises particles below 1680 microns.

8. The method of claim 1, wherein the wine has been bottled before being contacted with the cation exchange resin or molecularly imprinted medium.

9. The method of claim 1, wherein the cation exchange resin is in a cartridge and wherein the cartridge is attached to a string or rod.

10. A device for removing or reducing a biogenic amine from a liquid, comprising: an elongated body configured such that a portion of the elongated body engages a neck of a bottle, the elongated body comprising a lower portion, an upper portion, and an internal cavity that extends between the upper and lower portion, the lower portion defining one or more openings configured for allowing liquid to enter the internal cavity, the upper portion defining one or more openings configured for allowing liquid to exit the internal cavity, and wherein an effective amount of a cation exchange resin and/or molecularly imprinted medium selective for the moiety CH₂—CH₂—NH₂ to remove biogenic amines is disposed within the internal cavity.

11. A device for removing or reducing biogenic amines from a liquid, comprising:
an elongated body having an upper portion, a lower portion, and an internal cavity there between, wherein at least a part of the lower portion is configured for engaging a neck of a bottle, the lower portion defining one or more openings configured for allowing liquid to enter the internal cavity, and wherein the upper portion has an external diameter that is larger than an internal diameter of a neck of a bottle and comprises a porous layer configured for allowing liquid to exit the internal cavity;
a cover defining a space and disposed over at least a portion of the porous layer; and
a channel vent defined in a sidewall of the body, the channel vent extending between the lower portion and the upper portion.

12. The device of claim 11, wherein the internal cavity comprises a cation exchange resin and/or molecularly imprinted medium selective for the moiety CH₂—CH₂—NH₂.

13. The device of claim 12, wherein the internal cavity comprises from about 0.5 g to about 10 g of cation exchange resin or molecularly imprinted medium.

14. The device of claim 12, wherein the cation exchange resin and/or molecularly imprinted medium are disposed inside a cartridge.

15. The device of claim 12, wherein the cation exchange resin comprises sulfonic acid groups.

16. The device of claim 12, wherein the cation exchange resin comprises carboxylic acid groups.

17. The device of claim 12, wherein the cation exchange resin is a gel resin.

18. The device of claim 12, wherein the cation exchange resin is a macroreticular resin.

19. The device of claim 12, wherein the cation exchange resin comprises a copolymer divinylbenzene and acrylic acid, methacrylic acid, methyl acrylate, methyl methacrylate, ethyl vinyl benzene, or styrene.

20. The device of claim 12, wherein the cation exchange resin comprises particles below 1680 microns.

21. The device of claim 11, further comprising one or more annular ribs extending radially outwardly from at least a portion of an external surface of the lower portion of the body.

22. The device of claim 11, wherein the cover is removably affixed to a portion of the body.

23. The device of claim 11, wherein a porous layer is disposed within the upper portion.

24. The device of claim 23, wherein the porous layer is integrally formed with the upper portion and at least a portion of the porous layer extends radially outwardly from one side of the body to define a flute for pouring the liquid.

25. A device for removing or reducing biogenic amines from a liquid, comprising: an elongated body having an upper portion and a lower portion, at least a portion of the lower portion being sized to engage a neck of a bottle, the body further comprising an internal cavity between the upper and lower portions, and wherein a cation exchange resin and/or molecularly imprinted medium selective for the moiety CH₂—CH₂—NH₂ is disposed within the internal cavity.

26. The device of claim 25, wherein the upper portion further defines a spout adjacent a top surface of the upper portion.

27. The device of claim 26, wherein the spout is fluted.

28. The device of claim 25, further comprising an annular lip that extends radially outwardly from at least a portion of an external surface of the body and is configured to engage a top surface of the neck of the bottle.

29. The device of claim 25, further comprising one or more annular ribs that extend radially outwardly from at least a portion of the external surface of the body.

30. The device of claim 25, wherein the internal cavity comprises from about 0.5 g to about 10 g of cation exchange resin and/or molecularly imprinted medium.

31. The device of claim 25, wherein the cation exchange resin comprises sulfonic acid groups.

32. The device of claim 25, wherein the cation exchange resin comprises carboxylic acid groups.

33. The device of claim 25, wherein the cation exchange resin is a gel resin.

34. The device of claim 25, wherein the cation exchange resin is a macroreticular resin.

35. The device of claim 25, wherein the cation exchange resin comprises a copolymer divinylbenzene and acrylic acid, methacrylic acid, methyl acrylate, methyl methacrylate, ethyl vinyl benzene, or styrene.

36. The device of claim 25, wherein the cation exchange resin comprises particles below 1680 microns.

37. The device of claim 25, wherein the cationic exchange resin and/or molecularly imprinted medium is contained in a cartridge.

38. The device of claim 37, wherein the cartridge is removably affixed to the body.

39. The device of claim 37, wherein the cartridge is permanently affixed to the body.

40. The device of claim 37, further comprising a second cartridge comprising an additional filter material.

41. The device of claim 25, wherein the lower portion of the body defines one or more openings.

42. A device for removing or reducing amines from a liquid comprising: an elongated body having an upper portion, a lower portion, and an internal cavity there between, wherein: the lower portion defines a neck-receiving channel adjacent a bottom surface of the lower portion, the neck-receiving channel being configured to be urged in a radially outward direction to receive an upper portion of a neck of a bottle and bias radially inwardly to engage the upper portion of the neck, wherein a cation exchange resin and/or molecularly imprinted medium selective for the moiety CH₂—CH₂—NH₂ being disposed within the internal cavity.

43. The device of claim 42, further defining a spout adjacent a top surface of the upper portion of the body.

44. The device of claim 43, wherein the spout is fluted.

45. The device of claim 42, further defining one or more annular ribs extending radially outwardly from at least a portion of an external surface of the body.

46. The device of claim 42, wherein the cavity comprises from about 0.5 g to about 10 g of cation exchange resin.

47. The device of claim 42, wherein the cation exchange resin comprises sulfonic acid groups.

48. The device of claim 42, wherein the cation exchange resin comprises carboxylic acid groups.

49. The device of claim 42, wherein the cation exchange resin is a gel resin.

50. The device of claim 42, wherein the cation exchange resin is a macroreticular resin.

51. The device of claim 42, wherein the cation exchange resin comprises a copolymer divinylbenzene and acrylic acid, methacrylic acid, methyl acrylate, methyl methacrylate, ethyl vinyl benzene, or styrene.

52. The device of claim 42, wherein the cation exchange resin comprises particles below 1680 microns.

53. The device of claim 42, wherein the cationic exchange resin and/or molecularly imprinted medium is contained in a cartridge.

54. The device of claim 53, wherein the cartridge is removably affixed to the body.

55. The device of claim 53, wherein the cartridge is permanently affixed to the body.

56. The device of claim 53, further comprising a second cartridge comprising an additional filter material.
